(19) United States
(12) Patent Application Publication
(10) Pub. No.: US 2014/0049460 A1
(43) Pub. Date: Feb. 20, 2014

(54) Backlight module and driving method thereof

(71) Applicant: NOVATEK Microelectronics Corp., Hsin-Chu (TW)

(72) Inventors: Kuei-Chung Chang, Hsinchu County (TW); Hsien-Wen Lo, Hsinchu County (TW)

(73) Assignee: NOVATEK Microelectronics Corp., Hsin-Chu (TW)

(21) Appl. No.: 13/950,226

(22) Filed: Jul. 24, 2013

(30) Foreign Application Priority Data
Aug. 15, 2012 (TW) 101129480

(51) Int. Cl. G09G 3/34

(52) U.S. Cl. CPC G09G 3/3406
USPC 345/102

(57) ABSTRACT

A backlight module for a display device includes a determination module for generating a determination result according to a display content of the display device, a storage module for storing a plurality of on time duty signals, and an output module coupled to the determination module and the storage module for outputting one of the plurality of on time duty signals according to the determination result, to stably display the display content of the display device.

### BACKGROUND OF THE INVENTION

1. Field of the Invention

The present invention relates to a backlight module and a driving method thereof, and more particularly, to a backlight module and a driving method thereof to output one of a plurality of on time duty signals according to the display content of a display device, so as to stabilize the display content.

2. Description of the Prior Art

Consumers can arbitrarily select various size display devices equipped with different functions, and display device suppliers have been working on providing better output efficiency as well as higher display resolution of new products to satisfy different user requirements. One such area of research is to deal with the motion blur or flashing issues of the display devices. For small-size display devices utilizing a flashing backlight technique or display devices with single backlight source, a display content of the display device may be significantly affected because of the single backlight source for imaging operations. This is especially true when the display content corresponds to a brighter background, such as a circumstance with a standard viewing case (with a brighter background), the user may be easily affected by the flashing effect, which means the user may not easily sense brightness changes of the display content. Accordingly, the user could be uncomfortable while observing the display content to essentially decrease the observational quality. In the meanwhile, and the application range of the small-size display devices or the display devices utilizing the flashing backlight technique could be limited as well.

Therefore, it has become an important issue to provide a more efficiency backlight module and a driving method thereof to be applied to different background brightnesses in small-size display devices or the display devices utilizing the flashing backlight technique, so as to prevent the display devices from flashing effect generation of the display content.

### SUMMARY OF THE INVENTION

It is therefore an objective of the invention to provide a backlight module and a driving method thereof to output one of a plurality of on time duty signals according to the display content of a display device, so as to stabilize the display content.

An embodiment of the invention discloses a backlight module for a display device comprises a determination module for generating a determination result according to a display content of the display device, a storage module for storing a plurality of on time duty signals, and an output module coupled to the determination module and the storage module for outputting one of the plurality of on time duty signals according to the determination result, to stably display the display content of the display device.

An embodiment of the invention also discloses another method for driving a backlight module of a display device and the backlight module stores a plurality of on time duty signals. The method comprises generating a determination result according to a display content of the display device and outputting one of the plurality of on time duty signals according to the determination result to stably display the display content of the display device.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 illustrates a schematic diagram of a backlight module according to an embodiment of the invention.

FIG. 2 illustrates a detailed schematic diagram of the storage module shown in FIG. 1 according to an embodiment of the invention.

FIG. 3 illustrates a schematic diagram of a frame signal corresponding to a display content according to an embodiment of the invention.

FIG. 4 illustrates a flow chart of a driving backlight module process according to an embodiment of the invention.

FIG. 5 illustrates a flow chart of a flash parameter adjustment process according to an embodiment of the invention.

FIG. 6 illustrates a flow chart of a dynamic parameter adjustment process according to an embodiment of the invention.

### DETAILED DESCRIPTION

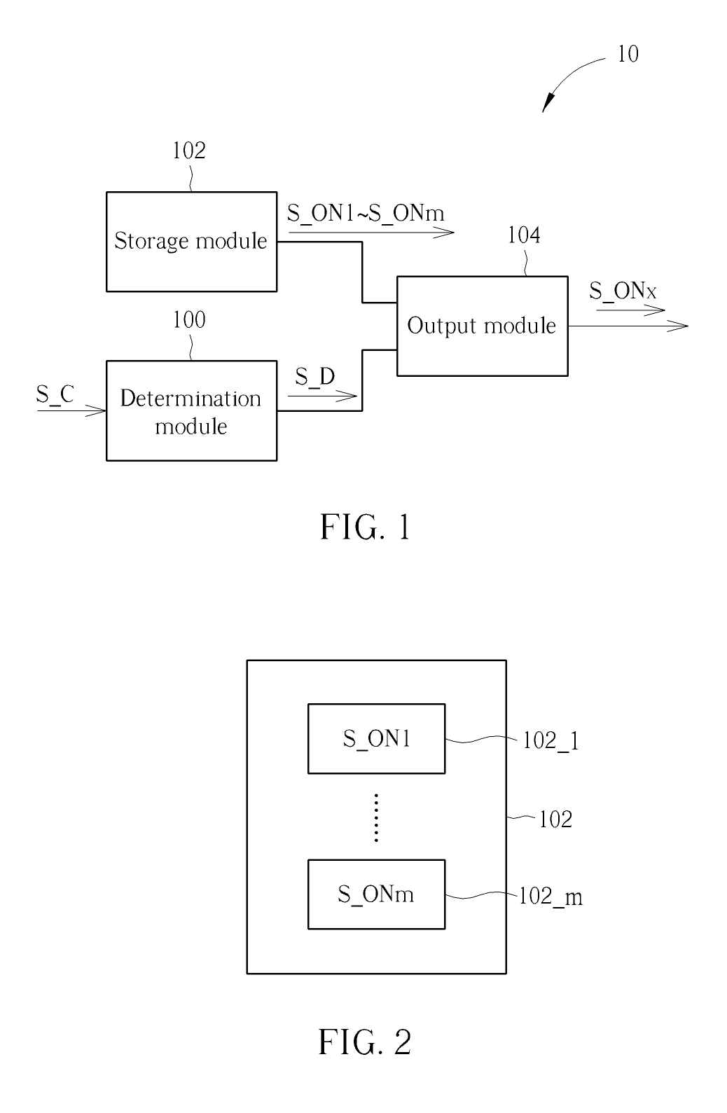

Please refer to FIG. 1, which illustrates a schematic diagram of a backlight module 10 according to an embodiment of the invention, wherein the backlight module 10 is installed in a display device (not shown in the figure) or the backlight module 10 is coupled to the display device to correspondingly control an output result of the display device. As shown in FIG. 1, the backlight module 10 includes a determination module 100, a storage module 102 and an output module 104. The determination module 100 generates a determination result S_D according to a display content S_C of the display device. The storage module 102 stores a plurality of on time duty signals S_ON1-S_ONm. The output module 104 is coupled to the determination module 100 and the storage module 102, and outputs one of the plurality of on time duty signals S_ON1-S_ONm (i.e. S_ONx) according to the determination result S_D, to stabilize a display content on the display device.

Preferably, the determination module 100 of the embodiment of the invention utilizes a histogram technique to transform the display content S_C into the determination result S_D. The display content S_C is formed via a plurality of pixel units (not shown in the figure), and the histogram technique should be well known to those skilled in the art to accumulate different display results at particular positions of the plurality of pixel units for displaying the display content S_C, such as a gray level value as 150 out of 255 from a pixel unit located at (100, 120), so as to determine whether one of the plurality of pixel units complies with a predetermined condition to correspondingly output the determination result S_D to the output module 104.

Noticeably, the display content S_C of the display device can be adjusted via a brightness parameter, a flash parameter and a dynamic parameter. Under such circumstances, the above parameters can be adaptively determined according to different circumstances for displaying the display content S_C, or the user can select the proper flash/dynamic parameter via adaptively adjusting the above parameters, so as to output the desired display content S_C. Preferably, amounts of the brightness parameter represent a brightness level of the display content S_C. If the amount of the brightness parameter is larger, the display content S_C is brighter. If the amount of the brightness parameter is smaller, the display content S_C is darker (or grayer). Amounts of the flash parameter represent a flash level of the display content S_C. If the amount of the flash parameter is larger, the display content S_C flashes more obviously. If the amount of the flash parameter is smaller, the display content S_C flashes less obviously. Amounts of the dynamic parameter represent a dynamic level of the display content S_C. If the amount of the dynamic parameter is larger, the display content S_C shifts more obviously. If the amount of the dynamic parameter is smaller, the display content S_C shifts less obviously. In simple, the output module 104 of the embodiment of the invention outputs one of the plurality of on time duty signals S_ON1-S_ONm according to the determination result S_D to adjust the flash parameter and the dynamic parameter of the display content S_C, so as to stably display the display content on the display device.

Please refer to FIG. 2, which illustrates a detailed schematic diagram of the storage module 102 shown in FIG. 1 according to an embodiment of the invention. As shown in FIG. 2, the storage module 102 further comprises a plurality of storage units 102_1-102_m for storing the plurality of on time duty signals S_ON1-S_ONm. Certainly, those skilled in the art can adaptively modify the storage way disclosed herein (i.e. via the plurality of storage units 102_1-102_m). Alternatively, a look-up table comprising the plurality of on time duty signals S_ON1-S_ONm or an adjustment unit pre-storing a predetermined on time duty signal for following adjustments can also be utilized to output one of the on time duty signals S_ON1-S_ONm, which is also in the scope of the invention.

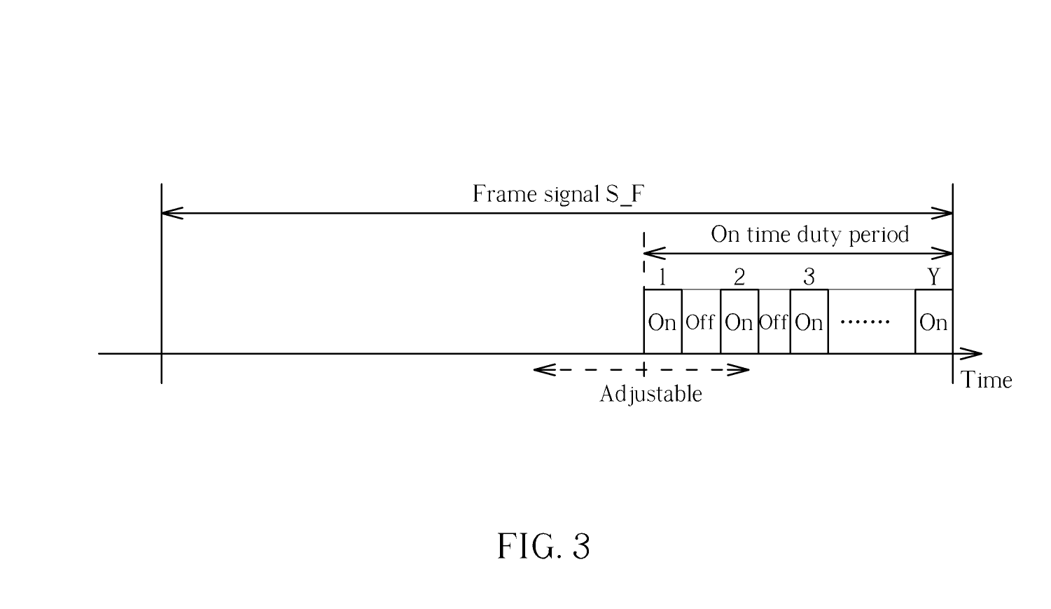

Please refer to FIG. 3, which illustrates a schematic diagram of a frame signal S_F corresponding to a display content S_C according to an embodiment of the invention, and the display content S_C is formed via a plurality of frame signals S_F. As shown in FIG. 3, the frame signal S_F corresponds to an on time duty period, and the on time duty period further comprises a plurality of repeated turning-on operations. In the embodiment, the symbols 1-Y represent the number of turning-on operation, and a turn-off operation exists between every two turning-on operations as well. Preferably, one of the on time duty signals S_ON1-S_ONm outputted by the output module 104 can be utilized to adjust a span of the on time duty period of the frame signal S_F, i.e. a turn-on period or a turn-off period of the backlight module 10 can be adjusted accordingly, so as to determine the display content S_C displayed on the display device.

Generally, the brightness parameter is first compared with a predetermined threshold to determine the brightness level of the display content S_C, e.g. whether the display content S_C is standard viewing case (with a brighter background) or a night viewing case and the predetermined threshold can be adaptively adjusted via different user requirements, which is not limiting the scope of the invention. When the brightness parameter is larger than the predetermined threshold and the output module 104 outputs a larger one of the plurality of on time duty signals S_ON1-S_ONm, the flash parameter can be correspondingly reduced to make the display content S_C flash less obviously. When the brightness parameter is larger than the predetermined threshold and the output module 104 outputs a smaller one of the plurality of on time duty signals S_ON1-S_ONm, the flash parameter can be correspondingly increased to make the display content S_C flash more obviously. Besides, when the brightness parameter is smaller than the predetermined threshold and the output module 104 outputs a larger one of the plurality of on time duty signals S_ON1-S_ONm, the flash parameter can be correspondingly fixed and it may be difficult for the user to determine whether the flash level of the display content S_C changes. When the brightness parameter is smaller than the predetermined threshold and the output module 104 outputs a smaller one of the plurality of on time duty signals S_ON1-S_ONm, the flash parameter can be correspondingly fixed as well. What is more, when the output module 104 outputs a larger one of the plurality of on time duty signals S_ON1-S_ONm, the dynamic parameter can be correspondingly increased to make the display content S_C shift more obviously. When the output module 104 outputs a smaller one of the plurality of on time duty signals S_ON1-S_ONm, the dynamic parameter can be correspondingly reduced to make the display content S_C shift less obviously.

In simple, the determination module 100 of the embodiment of the invention is utilized to determine the brightness parameter of the display content S_C. For example, when the display content S_C is the standard viewing case, the user may easily tell the changes of the flash level of the display content S_C via reducing the amount of the on time duty signal. Contrarily, it may be hard for the user to tell the changes of the flash level of the display content S_C via increasing the amount of the on time duty signal. On the other hand, when the display content S_C is the night viewing mode, it may be difficult for the user to tell the changes of the flash level of the display content S_C via increasing or reducing the amount of the on time duty signal. Besides, the determination module 100 of the embodiment of the invention is utilized to determine the dynamic parameter of the display content S_C to further determine whether or not to change the current amount of the on time duty signal. If the amount of the on time duty signal is increased, the user may easily tell the changes of the dynamic level of the display content S_C. In contrast, if the amount of the on time duty signal is reduced, it may be hard for the user to tell the changes of the dynamic level of the display content S_C. Accordingly, the user can utilize the determination module 100 to determine/estimate the amount of the brightness parameter, the flash parameter and the dynamic parameter to adaptively output one of the plurality of on time duty signals S_ON1-S_ONm, so as to output the proper display content S_C on the display device. Certainly, those skilled in the art can combine other adjustable parameters, such as the number of turn-on operation in each of the on time duty period or operational frequencies of the frame signal corresponding to the display content S_C, with the mentioned parameters (i.e. the brightness parameter, the flash parameter and the dynamic parameter) to be stored in the storage device 102, which is also in the scope of the invention.

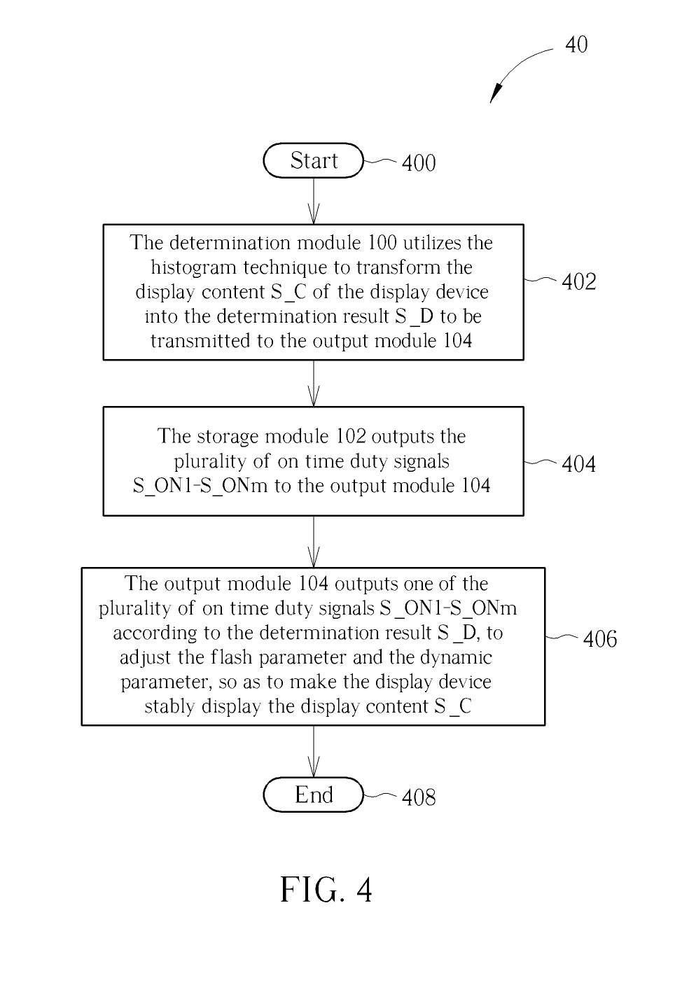

In the embodiment, the operations of the backlight module 10 combining with the display device can be summarized as a driving backlight module process 40, as shown in FIG. 4. The driving backlight module process 40 includes the steps as follows.

Step 400: Start.

Step 402: The determination module 100 utilizes the histogram technique to transform the display content S_C of the display device into the determination result S_D to be transmitted to the output module 104.

Step 404: The storage module 102 outputs the plurality of on time duty signals S_ON1-S_ONm to the output module 104.

Step 406: The output module 104 outputs one of the plurality of on time duty signals S_ON1-S_ONm according to the determination result S_D, to adjust the flash parameter and the dynamic parameter, so as to make the display device stably display the display content S_C.

Step 408: End.

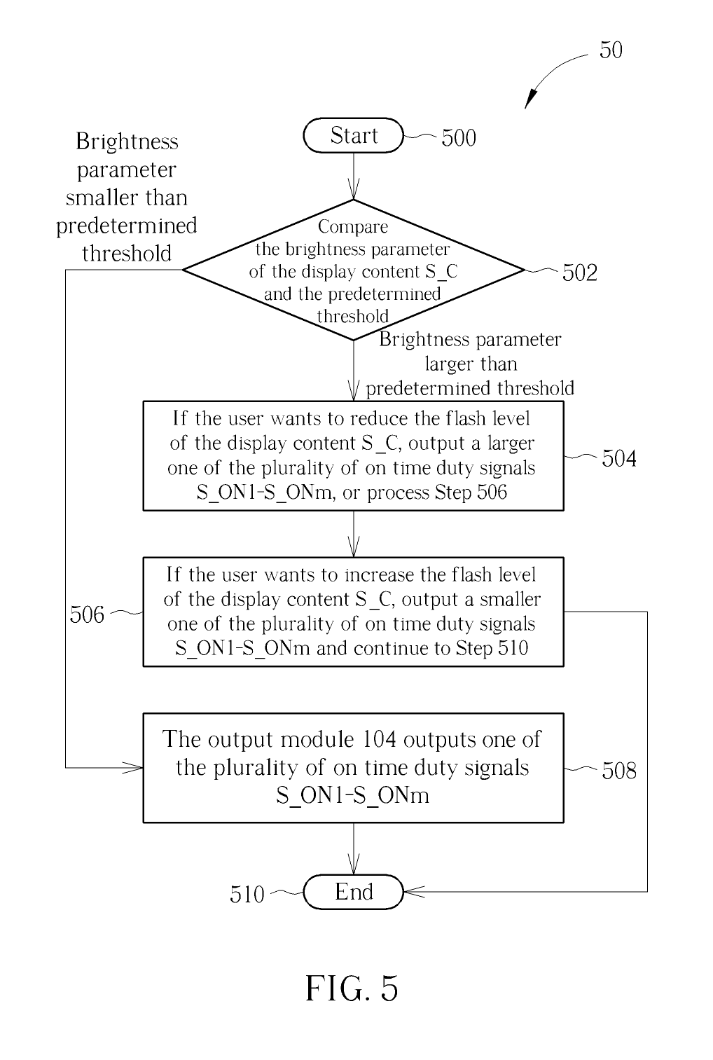

Moreover, the Step 406 of the driving backlight module process 40 for adjusting the flash parameter to stably display the display content S_C on the display device can be summarized as a flash parameter adjustment process 50, as shown in FIG. 5. The flash parameter adjustment process 50 includes the steps as follows.

Step 500: Start.

Step 502: Compare the brightness parameter of the display content S_C and the predetermined threshold. If the brightness parameter of the display content S_C is larger than the predetermined threshold, process Step 504. If the brightness parameter of the display content S_C is smaller than the predetermined threshold, process Step 508.

Step 504: If the user wants to reduce the flash level of the display content S_C, output a larger one of the plurality of on time duty signals S_ON1-S_ONm, or process Step 506.

Step 506: If the user wants to increase the flash level of the display content S_C, output a smaller one of the plurality of on time duty signals S_ON1-S_ONm and continue to Step 510.

Step 508: The output module 104 outputs one of the plurality of on time duty signals S_ON1-S_ONm.

Step 510: End.

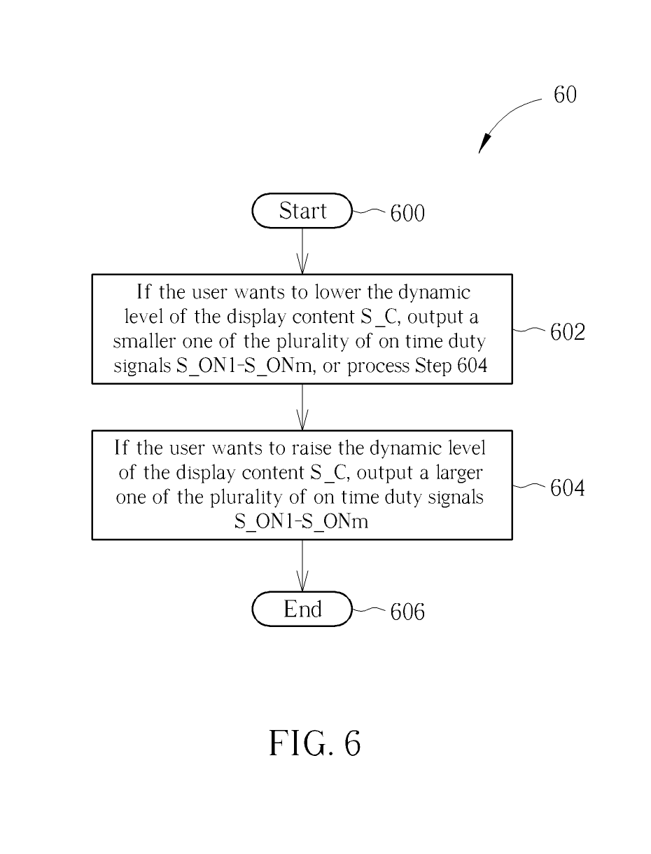

Furthermore, the Step 406 of the driving backlight module process 40 for adjusting the dynamic parameter to stably display the display content S_C on the display device can be summarized as a dynamic parameter adjustment process 60, as shown in FIG. 6. The dynamic parameter adjustment process 60 includes the steps as follows.

Step 600: Start.

Step 602: If the user wants to lower the dynamic level of the display content S_C, output a smaller one of the plurality of on time duty signals S_ON1-S_ONm, or process Step 604.

Step 604: If the user wants to raise the dynamic level of the display content S_C, output a larger one of the plurality of on time duty signals S_ON1-S_ONm.

Step 606: End.

The detailed operations of the driving backlight module process 40, the flash parameter adjustment process 50 and the dynamic parameter adjustment process 60 can be understood from the mentioned embodiments shown in FIG. 1 to FIG. 3 and related paragraphs thereof, which is not described hereinafter. Besides, in Step 508, the brightness parameter of the display content S_C is smaller than the predetermined threshold. Thus, the user cannot easily recognize the changes of the flash level of the display content S_C no matter what the output module 104 outputs as a smaller/larger one of the plurality of on time duty signals S_ON1-S_ONm, which means the output module 104 only has to randomly output one of the plurality of on time duty signals S_ON1-S_ONm. Certainly, the user can adaptively adjust the output result from the plurality of on time duty signals S_ON1-S_ONm in Step 508 according to different user requirements, which is also in the scope of the invention.

Noticeably, the determination module 100 of the invention can further comprise a brightness parameter determination unit, a flash parameter determination unit and a dynamic parameter determination unit. The brightness parameter determination unit cooperates with the flash parameter determination unit to process the driving backlight module process 40 and the flash parameter adjustment process 50 according to the brightness level of the display content S_C, or the dynamic parameter determination unit can independently process the driving backlight module process 40 and the dynamic parameter adjustment process 60. Certainly, the determination module 100 can simultaneously process the driving backlight module process 40, the flash parameter adjustment process 50 and the dynamic parameter adjustment process 60 to generate the determination S_D according to the display content S_C, and accordingly, the output module 104 outputs one of the plurality of the on time duty signals S_ON1-S_ONm, which is also in the scope of the invention.

In summary, the invention provides a backlight module coupled to a display device and a driving method thereof, which utilizes a determination module to determine a display content of the display device, so as to correspondingly output one of a plurality of on time duty signals and to adjust a flash parameter and a dynamic parameter of the display content. Therefore, according to different brightness parameters of the display content or different user requirements, the display content can be stably displayed on the display device. In comparison with the prior art, the embodiment of the invention can be applied to small-size display devices as well as display devices utilizing the flashing backlight technique, so as to adaptively eliminate the motion blur/flashing issues on the display devices and to enlarge the application range of the display device.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A backlight module for a display device, comprising:
a determination module for generating a determination result according to a display content of the display device;
a storage module for storing a plurality of on time duty signals; and
an output module coupled to the determination module and the storage module for outputting one of the plurality of on time duty signals according to the determination result, to display the display content of the display device.

2. The backlight module of claim 1, wherein the display content comprises a brightness parameter representing a brightness level of the display content, which means the display content is brighter with a larger value of the brightness parameter and the display content is grayer with a smaller value of the brightness parameter, a flash parameter representing a flash level of the display content, which means the display content flashes more obviously with a larger value of the flash parameter and the display content flashes less obviously with a smaller value of the flash parameter, and a dynamic parameter representing a dynamic level of the display content, which means the display content shifts more obviously with a larger value of the dynamic parameter and the display content shifts less obviously with a smaller value of the dynamic parameter.

3. The backlight module of claim 2, wherein the output module adjusts the flash parameter and the dynamic parameter according to the plurality of on time duty signals to be outputted and the brightness parameter, to make the display device display the display content.

4. The backlight module of claim 3, wherein when the brightness parameter is larger than a predetermined threshold and the output module outputs a larger one of the plurality of on time duty signals, the flash parameter is reduced to lower the flash level of the display content.

5. The backlight module of claim 3, wherein when the brightness parameter is larger than a predetermined threshold and the output module outputs a smaller one of the plurality of on time duty signals, the flash parameter is increased to raise the flash level of the display content.

6. The backlight module of claim 3, wherein when the brightness parameter is smaller than a predetermined threshold and the output module outputs a larger one of the plurality of on time duty signals, the flash parameter is fixed to maintain the flash level of the display content.

7. The backlight module of claim 3, wherein when the brightness parameter is smaller than a predetermined threshold and the output module outputs a smaller one of the plurality of on time duty signals, the flash parameter is fixed to maintain the flash level of the display content.

8. The backlight module of claim 3, wherein when the output module outputs a larger one of the plurality of on time duty signals, the dynamic parameter is increased to raise the dynamic level of the display content.

9. The backlight module of claim 3, wherein when the output module outputs a smaller one of the plurality of on time duty signals, the dynamic parameter is reduced to lower the dynamic level of the display content.

10. The backlight module of claim 1, wherein the storage module comprises a plurality of storage units for storing the plurality of on time duty signals.

11. The backlight module of claim 1, wherein the determination module utilizes a histogram technique to transform the display content into the determination result.

12. A method for driving a backlight module of a display device, the method comprising:
generating a determination result according to a display content of the display device; and
outputting one of a plurality of on time duty signals according to the determination result, to display the display content of the display device.

13. The method of claim 12, wherein the display content comprises a brightness parameter representing a brightness level of the display content, which means the display content is brighter with a larger value of the brightness parameter and the display content is grayer with a smaller value of the brightness parameter, a flash parameter representing a flash level of the display content, which means the display content flashes more obviously with a larger value of the flash parameter and the display content flashes less obviously with a smaller value of the flash parameter, and a dynamic parameter representing a dynamic level of the display content, which means the display content shifts more obviously with a larger value of the dynamic parameter and the display content shifts less obviously with a smaller value of the dynamic parameter.

14. The method of claim 13, further comprising utilizing an output module for adjusting the flash parameter and the dynamic parameter according to the plurality of on time duty signals to be outputted and the brightness parameter, to make the display device display the display content.

15. The method of claim 14, wherein when the brightness parameter is larger than a predetermined threshold and the output module outputs a larger one of the plurality of on time duty signals, the flash parameter is reduced to lower the flash level of the display content.

16. The method of claim 14, wherein when the brightness parameter is larger than a predetermined threshold and the output module outputs a smaller one of the plurality of on time duty signals, the flash parameter is increased to raise the flash level of the display content.

17. The method of claim 14, wherein when the brightness parameter is smaller than a predetermined threshold and the output module outputs a larger one of the plurality of on time duty signals, the flash parameter is fixed to maintain the flash level of the display content.

18. The method of claim 14, wherein when the brightness parameter is smaller than a predetermined threshold and the output module outputs a smaller one of the plurality of on time duty signals, the flash parameter is fixed to maintain the flash level of the display content.

19. The method of claim 14, wherein when the output module outputs a larger one of the plurality of on time duty signals, the dynamic parameter is increased to raise the dynamic level of the display content.

20. The method of claim 14, wherein when the output module outputs a smaller one of the plurality of on time duty signals, the dynamic parameter is reduced to lower the dynamic level of the display content.

21. The method of claim 12, further comprising utilizing a plurality of storage units for storing the plurality of on time duty signals.

22. The method of claim 12, further comprising utilizing a histogram technique to transform the display content into the determination result.
